(19) United States
(12) Patent Application Publication
(10) Pub. No.: US 2025/0207666 A1
(43) Pub. Date: Jun. 26, 2025

(54) ELECTRICALLY CONDUCTIVE SEALING ELEMENT

(71) Applicant: Parker-Hannifin Corporation, Cleveland, OH (US)

(72) Inventors: Ronald J. THOMAS, Marion, NY (US); Thomas R. SMITH, Nacogdoches, TX (US); Aydin AYKANAT, Draper, UT (US)

(73) Assignee: Parker-Hannifin Corporation, Cleveland, OH (US)

(21) Appl. No.: 18/846,310

(22) PCT Filed: Nov. 14, 2023
(86) PCT No.: PCT/US2023/079561

§ 371 Date: Sep. 12, 2024

Related U.S. Application Data
(60) Provisional application No. 63/383,745, filed on Nov. 15, 2022.

(51) Int. Cl. F16J 15/3284; F16J 15/54

(52) U.S. Cl. CPC F16J 15/3284; F16J 15/54

(57) ABSTRACT

An assembly configuration prevents eddy or other electrical currents from flowing through the bearings that support relative motion of two components by incorporation of a sealing element that includes an electrically conductive additive material, thereby providing a conductive pathway to shunt the electrical currents externally from the bearings or around the bearings. The sealing element is therefore a two-function sealing element that seals the system components and additionally shunts the electrical currents externally from or around the bearings to prevent current flow through the bearings. A material of the contacting sealing element is electrically conductive, and in this manner, the sealing element is sufficiently electrically conductive to provide an electrically conductive path between the two components to shunt the eddy currents around the bearings. The sealing element includes an electrically non-conductive matrix material, and an electrically conductive additive material incorporated into the electrically non-conductive matrix material.

### RELATED APPLICATIONS

This application claims the benefit of U.S. Provisional Application No. 63/383,745 filed on Nov. 15, 2022, the content of which is incorporated here by reference.

### FIELD OF INVENTION

The present application relates to sealing elements particularly used to seal components in applications in which a seal is required between components that move relative to each other with the support of a bearing structure, including configurations that address handling eddy currents or other electrical discharges that are generated and undesirably flow through the bearing structure.

### BACKGROUND OF THE INVENTION

There are many applications in which there are two components that move relative to one another. Relative motion or relative movement as considered in this disclosure includes two components that both are in motion relative to one another, or a moveable component that moves relative to a stationary component. The relative motion of the components often is supported by a bearing structure between the two components. In addition, gaps between the two components often need to be sealed by a sealing element to prevent ingress of moisture, dust, or other contaminants into the overall system.

In many applications, the relative motion of components may be driven by an electric drive or an inverter drive. One side effect of electric or inverter drives is that such drives impart eddy currents through the components. These eddy currents in particular flow between two components of relative motion by passing through the bearing structure that supports such relative motion. The eddy currents lead to static discharges that occur within the bearing structure. In other applications, relative motion of the components can lead to a build-up of static charge that may be discharged as an electric current through the bearing structure. The flow of eddy currents or other electric discharge currents through the bearing structure causes the bearing structure to become fluted or otherwise damaged. This damage ultimately can lead to bearing failure.

For example, electric motors include a rotating component (rotor) that rotates relative to a stationary component (stator), with the rotating component being speed controlled by an electric drive, for example an inverter drive. As referenced above, one side effect of electric or inverter drives in conventional electric motors is that such drives impart eddy currents through the motor components. These eddy currents in the motor system in particular flow between the rotor and stator by passing through the motor bearings that support rotation of the rotor relative to the stator. The eddy currents lead to static discharges that occur within the motor bearings, causing the bearings to become fluted or otherwise damaged. This damage ultimately can lead to motor bearing failure.

As another example, electric braking systems, such as for example electric aircraft braking systems, operate by relative motion of a drive shaft being driven through a brake housing, and the relative motion of the drive shaft relative to the housing is supported by one or more bearings. As result of the relative motion, a static electric charge can build up between the drive shaft and the brake housing, which can be discharged through the bearings. As another example, rotary systems, such as for example helicopter rotors or wind turbine blades, operate by rotation supported by a bearing structure including an outer race and an inner race rotating relative to each other about a series of supporting ball bearings. As result of the relative motion, a static charge can build up between the bearing races, which can be discharged through the bearing structure. Similarly in these examples, discharged electric currents through the bearing structures s can cause the bearings to become damaged, which ultimately can lead to bearing failure. These are non-limiting examples, and other applications that employ relative motion of components supported by one or more bearings may experience similar damage or bearing failure.

To prevent damage caused by eddy currents or other electric discharge currents flowing through the bearing structure, conventional configurations have employed additional components to either electrically insulate the bearings, or to shunt the eddy or electrical discharge currents around the bearings, to prevent current flow through the bearings. For insulation solutions, bearings have been covered or isolated by electrically non-conductive layers or components to block electrical currents from flowing through the bearings. Alternatively to electrically insulating the bearings, other conventional configurations have employed additional electrically conductive components to shunt the electrical currents around the bearings to avoid the current flow through the bearings. Shunting components, for example, have included carbon brushes and fiber brushes that are made of a conductive material through which the electrical currents flow rather than through the bearings.

Conventional solutions that use conductive brushes or insulated bearings are expensive and complex to implement. The additional components require additional space to install which may not be available in electric motors or other relative motion systems for many applications, and such additional components must be bolted on, adhered, or otherwise fixed in place. In addition, contamination of conductive brushes can result in an ineffective shunt current path resulting in ineffective current transmission, in which case at least a portion of the damaging electrical currents still flows through the bearings.

### SUMMARY OF INVENTION

There is a need in the art, therefore, for an improved configuration of a system that has at least two components that move relative to each other supported by one or more bearing structures, that prevents eddy currents or other electric currents from flowing through the bearing structure(s). This problem is addressed in the current application by employing a sealing element that includes an electrically conductive additive material, thereby providing a conductive pathway to shunt the electrical current externally from the bearings or around the bearings. Embodiments of the present application thus employ a two-function sealing element that: (1) seals the system components as is conventional, and (2) additionally shunts the electrical currents externally from or around the bearings to prevent current flow through the bearings. Accordingly, a material of the contacting sealing element is electrically conductive, and in this manner, embodiments of the present application modify the conventional sealing element to be sufficiently electrically conductive to provide an electrically conductive path between the components of relative motion to shunt the electrical currents around the bearing structures.

An aspect of the invention, therefore, is a sealing element for sealing two components that operate by relative motion that is positioned to shunt electrical currents. In exemplary embodiments, the sealing element includes an electrically non-conductive matrix material, and an electrically conductive additive material incorporated into the electrically non-conductive matrix material. The electrically conductive additive material is incorporated into the electrically non-conductive matrix material in an amount that renders the sealing element sufficiently conductive to shunt an electrical current between the two components that operate by relative motion.

Another aspect of the invention is an assembly including a first component and a second component, wherein the first component and the second component operate by relative motion to each; a drive system that drives the relative motion of the first component and the second component; and at least one bearing structure that supports the relative motion of the first component and the second component. The assembly includes a sealing assembly that includes a sealing element according to any of the embodiments, wherein the sealing element is positioned and is sufficiently conductive to shunt an electric current between the first component and the second component such that the electric current flows externally from or around the at least one bearing structure.

Another aspect of the invention is an assembly including a first component and a second component, wherein the first component and the second component operate by relative motion to each other; a drive system that drives the relative motion of the first component and the second component; and at least one bearing structure that supports the relative motion of the first component and the second component. The assembly includes a sealing assembly according to any of the embodiments including a sealing element and an energizing element, wherein the sealing element of the sealing assembly is positioned and is sufficiently conductive to shunt an electric current between the first component and the second component such that the electric current flows externally from or around the at least one bearing structure.

In an exemplary embodiment, an improved motor assembly configuration prevents eddy currents from flowing through the motor bearings. To achieve such enhancement, a sealing element includes an electrically conductive additive material, thereby providing a conductive pathway to shunt the eddy current externally from the motor bearings or around the motor bearings. Embodiments of the present application thus employ a two-function sealing element that: (1) seals the motor components as is conventional, and (2) additionally shunts the eddy currents externally from or around the motor bearings to prevent current flow through the motor bearings. Accordingly, a material of the contacting sealing element is electrically conductive, and in this manner, embodiments of the present application modify the conventional sealing element to be sufficiently electrically conductive to provide an electrically conductive path between the motor rotor and stator to shunt the eddy currents around the motor bearings.

An aspect of the invention, therefore, is a sealing element for sealing a rotor and a stator in an electric motor that is positioned to shunt eddy currents. In exemplary embodiments, the sealing element includes an electrically non-conductive matrix material, and an electrically conductive additive material incorporated into the electrically non-conductive matrix material. The electrically conductive additive material is incorporated into the electrically non-conductive matrix material in an amount that renders the sealing element sufficiently conductive to shunt an eddy current between the rotor and the stator.

In an exemplary embodiment of the sealing element, the electrically conductive additive material is incorporated in the electrically non-conductive matrix material as at least one of particulates, fibers, or powder.

In an exemplary embodiment of the sealing element, a percent composition of the electrically conductive additive material relative to an entire material composition of the sealing element is 10-65%.

In an exemplary embodiment of the sealing element, the electrically non-conductive matrix material includes Polytetrafluoroethylene (PTFE), a thermoplastics material, or a polyurethane.

In an exemplary embodiment of the sealing element, the electrically non-conductive matrix material includes an elastomeric material.

In an exemplary embodiment of the sealing element, the electrically conductive additive material includes carbon particulates or carbon fibers.

In an exemplary embodiment of the sealing element, the electrically conductive additive material includes a metallic filler formed as a powder or fibers of a metallic material.

In an exemplary embodiment of the sealing element, the metallic material includes one or more of bronze, stainless steel, copper, silver, or gold.

Another aspect of the invention is a sealing assembly including a sealing element according to any of the embodiments, and an energizing member embedded within a portion of the sealing element that aids in energizing the sealing element. The energizing member may be a spring, such as for example a cantilever spring, a coil spring, a canted coil spring, a helical spring, a garter spring or an elastomeric spring.

Another aspect of the invention is a motor assembly including a stator; a rotor that rotates relative to the stator; an electric motor system that includes an electric motor and a drive system that is driven by the electric motor and that drives the rotation of the rotor relative to the stator; a motor bearing that supports the rotation of the rotor relative to the stator; and a sealing assembly that includes the sealing element according to any of the embodiments, wherein the sealing element is positioned and is sufficiently conductive to shunt an eddy current between the rotor and the stator such that the eddy current flows externally from or around the motor bearing.

Another aspect of the invention is a motor assembly including a stator; a rotor that rotates relative to the stator; an electric motor system that includes an electric motor and a drive system that is driven by the electric motor and that drives the rotation of the rotor relative to the stator; a motor bearing that supports the rotation of the rotor relative to the stator; and a sealing assembly according to any of the embodiments including a sealing element and an energizing element, wherein the sealing element of the sealing assembly is positioned and is sufficiently conductive to shunt an eddy current between the rotor and the stator such that the eddy current flows externally from or around the motor bearing.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting an exemplary first configuration of a sealing assembly including a sealing element made of an electrically conductive material.

FIG. 2 is a drawing depicting an exemplary second configuration of a sealing assembly including a sealing element made of an electrically conductive material.

FIG. 3 is a drawing depicting an exemplary third configuration of a sealing assembly including a sealing element made of an electrically conductive material.

FIG. 4 is a drawing depicting an exemplary motor assembly that has a sealing assembly including a sealing element made of an electrically conductive material.

FIG. 5 is a drawing depicting a first exemplary assembly configuration that has a sealing assembly including a sealing element made of an electrically conductive material.

FIG. 6 is a drawing depicting a second exemplary assembly configuration that has a sealing assembly including a sealing element made of an electrically conductive material.

FIG. 7 is a drawing depicting a third exemplary assembly configuration that has a sealing assembly including a sealing element made of an electrically conductive material.

FIG. 8 is a drawing depicting a fourth exemplary assembly configuration that has a sealing assembly including a sealing element made of an electrically conductive material.

FIG. 9 is a drawing depicting a fifth exemplary assembly configuration that has a sealing assembly including a sealing element made of an electrically conductive material.

FIG. 10 is a drawing depicting a sixth exemplary assembly configuration that has a sealing assembly including a sealing element made of an electrically conductive material.

FIG. 11 is a drawing depicting a seventh exemplary assembly configuration that has a sealing assembly including a sealing element made of an electrically conductive material.

### DETAILED DESCRIPTION

Embodiments of the present application will now be described with reference to the drawings, wherein like reference numerals are used to refer to like elements throughout. It will be understood that the figures are not necessarily to scale.

As referenced above, an improved configuration of a system, that has at least two components that move relative to each other supported by one or more bearing structures, prevents eddy currents or other electric currents from flowing through the one or more bearing structures. Electric current flow through the bearings is prevented by a sealing element that includes an electrically conductive additive material, thereby providing a conductive pathway to shunt the electric current externally from the bearings or around the bearings. Embodiments of the present application thus employ a two-function sealing element that: (1) seals the system components as is conventional, and (2) additionally shunts the electrical currents externally from or around the bearing structures to prevent current flow through the bearings. Accordingly, a material of the contacting sealing element is electrically conductive, and in this manner, embodiments of the present application modify the conventional sealing element to be sufficiently electrically conductive to provide an electrically conductive path between the components of relative motion to shunt the electric currents around the motor bearings.

As referenced above, an improved motor assembly configuration prevents eddy currents from flowing through the motor bearings. Eddy current flow through the motor bearings is prevented by employing a sealing element that includes an electrically conductive additive material, thereby providing a conductive pathway to shunt the eddy current externally from the motor bearings or around the motor bearings. Embodiments of the present application thus employ a two-function sealing element that: (1) seals the motor components including the rotor and stator as is conventional, and (2) additionally shunts the eddy currents externally from or around the motor bearings to prevent current flow through the motor bearings. Accordingly, a material of the contacting sealing element is electrically conductive, and in this manner, embodiments of the present application modify the conventional sealing element to be sufficiently electrically conductive to provide an electrically conductive path between the motor rotor and stator to shunt the eddy currents externally from or around the motor bearings.

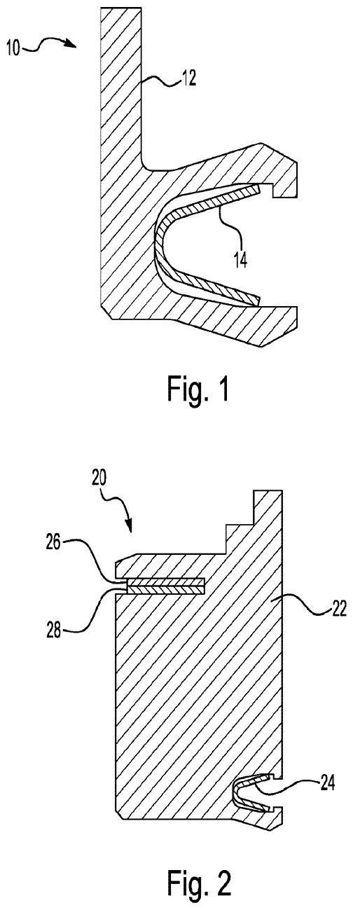

It will be appreciated that a sealing element including an electrically conductive material may be employed in a variety of sealing assembly configurations, including a wide variety of shapes and applications. For example, FIG. 1 is a drawing depicting an exemplary first configuration of a sealing assembly 10 that includes a sealing element 12 and an energizing member 14 embedded within a portion of the sealing element 12 that aids in energizing the sealing element 12. In this example, the energizing member is configured as a spring, and in particular a cantilever spring. Other examples of a suitable energizing member may include a coil spring, a canted coil spring, a helical spring, a garter spring or an elastomeric spring. As referenced above, the sealing element 12 includes an electrically conductive material to render the sealing element 12 sufficiently electrically conductive to provide an electrically conductive path between two components of relative motion to shunt eddy currents or other electric discharge currents externally from or around the bearing structure or structures.

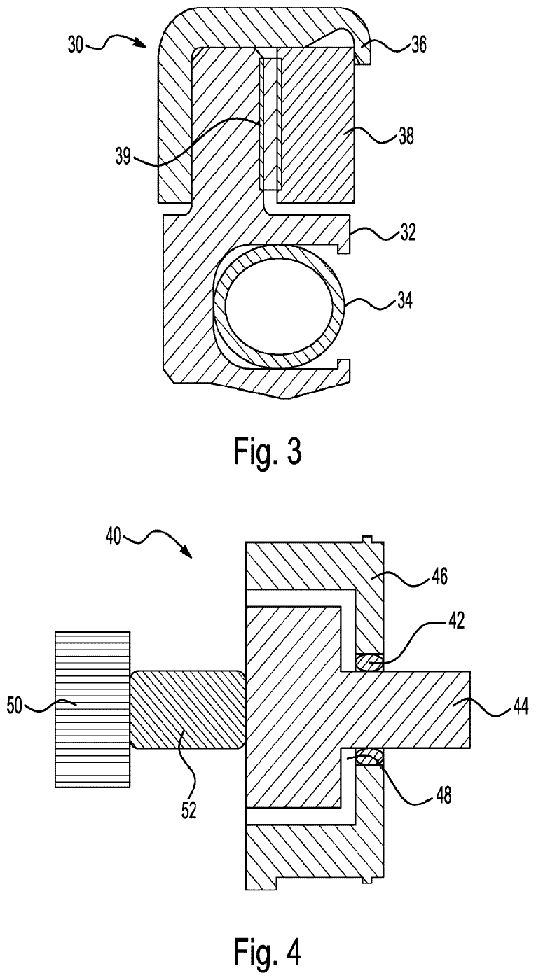

As referenced above, the configuration of the electrically conductive sealing element is not limited to any particular shape or application, and therefore can be employed in a variety of system configurations. FIGS. 2 and 3, therefore, illustrate two additional non-limiting examples of exemplary configurations of sealing assemblies including an electrically conductive sealing element. FIG. 2 is a drawing depicting a sealing assembly 20 that includes a sealing element 22 having an alternative shape, and an energizing member (e.g., a cantilever spring) 24 embedded within a portion of the sealing element 22 that aids in energizing the sealing element. Similarly as in the previous embodiment, the sealing element 22 includes an electrically conductive material to render the sealing element 22 sufficiently electrically conductive to provide an electrically conductive path between the components of relative motion to shunt the eddy currents or other electrical discharge currents externally from or around the bearing structure or structures. In this particular configuration, the sealing assembly 20 further includes a pair of retention bands 26 and 28 embedded within a second portion of the sealing element that aids in retaining the sealing element.

FIG. 3 is a drawing depicting a sealing assembly 30 that includes a sealing element 32 having an alternative shape, and an energizing member (e.g., a coil spring in this example) 34 embedded within a first portion of the sealing element that aids in energizing the sealing element. Similarly as in the previous embodiments, the sealing element 32 includes an electrically conductive material to render the sealing element 32 sufficiently electrically conductive to provide an electrically conductive path between the components of relative motion to shunt the eddy currents or other electrical discharge current externally from or around the bearing structure or structures. In this particular configuration of FIG. 3, the sealing assembly 30 further includes an outer case 36 positioned at least in part on a radially outward portion of the sealing element, and an inner washer 38 positioned at least in part on a radially inward portion of the sealing element. The sealing assembly 30 further includes an additional gasket 39 located between the sealing element 32 and the inner washer 38.

As referenced above, each of the sealing elements Dec. 22, 1932 is an electrically conductive sealing element that includes an electrically conductive material to render each of the sealing elements sufficiently electrically conductive to provide an electrically conductive path between at least two components that operate by relative motion to shunt the eddy currents or other electrical currents externally from or around the bearing structure or structures that support the relative motion between the components. In exemplary embodiments, an electrically conductive additive material is incorporated into an electrically non-conductive matrix material. The electrically conductive additive material may be added into the electrically non-conductive matrix material as particulates, fibers, powder, or comparable filler configuration during formation of the sealing element. A percent composition of the electrically conductive additive material relative to the entire material composition of the sealing element may be from about 10-65%. The specific percent composition of the electrically conductive additive material versus the electrically non-conductive matrix material may be varied as suitable for any particular application, and may depend on environmental or use conditions such as temperature, pressure, moisture content, and other parameters associated with the particular end-use application. The electrical conductivity may be optimized by homogeneous dispersion of electrically conductive additive material in the electrically non-conductive matrix material. The conductive sealing element may be used in wet or dry applications, a wet application being an application in which a lubricant, such as an oil or grease, is provided to lubricate the relative motion of the system components. Electrical conductivity further may be enhanced by using the electrically conductive sealing element in combination with an electrically conductive lubricant material (oil or grease) that further has an electrically conductive additive.

The following provides non-limiting examples of material compositions of the electrically conductive sealing element. Other suitable combinations of electrically non-conductive matrix materials and electrically conductive additive materials may be employed as may be suitable for any particular application. One common material employed in sealing elements for electric motors or other systems with movable components is Polytetrafluoroethylene (PTFE). PTFE is natively electrically non-conductive. Another class of common materials employed in sealing elements for electric motors or other systems with movable components is elastomeric materials, which may include any of various natural or synthetic rubbers. Elastomeric materials also are natively electrically non-conductive. Another class of common materials employed in sealing elements for electric motors or other systems with movable components is thermoplastic materials or polyurethane materials. Thermoplastic and polyurethane materials also are natively electrically non-conductive. In exemplary embodiments of the present application, PTFE, an elastomeric material, a thermoplastics material, or a polyurethane may be employed as the electrically non-conductive matrix material of the sealing element. For use with a PTFE, elastomeric material, thermoplastics material, or a polyurethane electrically non-conductive matrix material, the electrically conductive additive material may include one or more of carbon particulates or carbon fibers, or a metallic filler formed as a powder or fibers of a metallic material such as, for example, bronze, stainless steel, copper, silver, or gold. Particulate particle size, fiber size, and/or fiber orientation of a given electrically conductive additive material may be optimized for sufficient electrical conductivity for incorporation within a given electrically non-conductive matrix material and/or end use application.

A sealing assembly including an electrically conductive sealing element, such as configured according to any of the above embodiments, may be employed in a motor assembly to provide the requisite shunting of eddy currents externally from or around the motor bearings. FIG. 4 is a drawing depicting an exemplary motor assembly 40 that has a sealing assembly 42 including a sealing element made of an electrically conductive material. The sealing assembly 42, for example, may be configured as any of sealing assemblies 10, 20, or 30 of the above embodiments. The motor assembly further includes a rotating member 44, such as a rotor, that rotates relative to a stationary member, such as a stator 46. The rotation of the rotating member (rotor) 44 is supported by at least one motor bearing 48. The sealing assembly 42 seals a gap between the rotor 44 and stator 46 adjacent to the motor bearing 48. The sealing assembly 42 may be positioned between the rotor and the stator at a position selected to shut eddy currents externally from or around the motor bearings. By positioning the sealing assembly 42 including an electrically conductive sealing element between the rotor and stator, and such as for example adjacent to the motor bearing 48, eddy currents are shunted externally from or around the motor bearing 48. The motor assembly further includes an electric motor assembly that includes an electric motor 50 and a drive system 52, such as a gearing train or comparable mechanical drive system that is driven by the electric motor and that drives the rotation of the rotor relative to the stator.

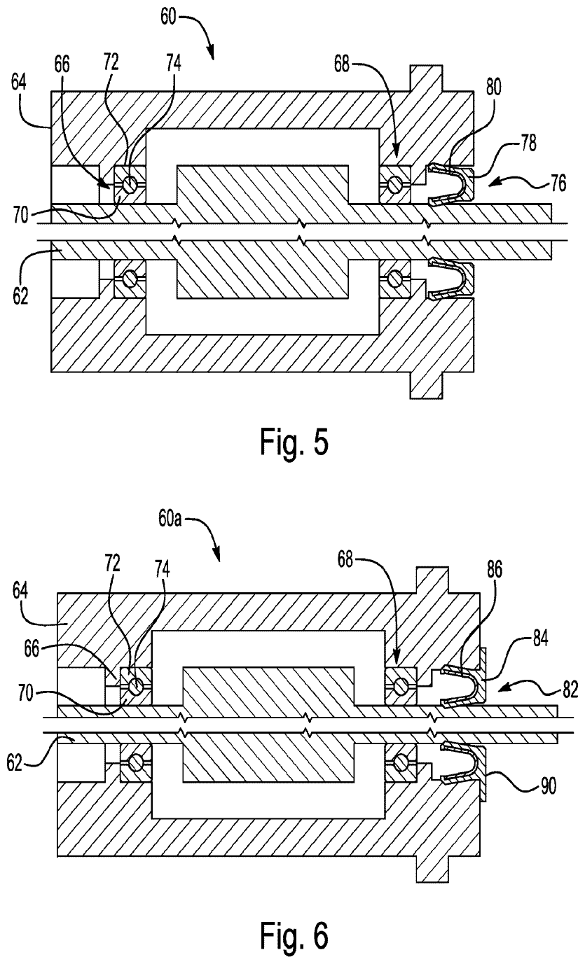

Exemplary applications for use of the sealing assembly of the current application, including an electrically conductive sealing element, are not limited specifically to electric motors, but may be employed in any suitable application that employs relative motion of components. FIG. 5 is a drawing depicting an assembly configuration 60 that includes a first component 62 and a second component 64 that operate by relative motion to each other. Again, relative motion encompasses both the first and second components being moveable components that rotate or otherwise move relative to each other, and one of the first component or the second component being a stationary component and the other of the first component or the second component being a moveable component that rotates or otherwise moves relative to the stationary component. The relative motion is supported by one or more bearing structures, which in the depicted example include two bearing structures 66 and 68. Any suitable bearing structures may be employed. In this depicted example, each of the bearing structures 66 and 68 includes an inner race 70 and outer race 72 that rotate or otherwise move relative to each other about one or more bearing balls 74.

A gap separating the first component 62 and the second component 64 is sealed by a sealing assembly 76 that may be configured according to any of the embodiments. In the example of FIG. 5, the sealing assembly 76 includes an electrically conductive PTFE-based sealing element 78 and an energizing element 80. In this particular example, the energizing element 80 is configured as a cantilever spring.

FIGS. 6-11 depict additional, non-limiting examples of assembly configurations that employ a sealing assembly in accordance with embodiments of the current disclosure. In these examples, the relative motion components and bearing structures are comparable as in FIG. 5, and therefore like components are identified with like reference numerals in these figures. In the example configuration 60a of FIG. 6, a gap separating the first component 62 and the second component 64 is sealed by a sealing assembly 82. In this example, the sealing assembly 82 includes an electrically conductive PTFE-based sealing element 84, and an energizing element 86 that also is configured as a cantilever spring. The configuration of the sealing element 84 is a flanged sealing element includes a flange 90, shaped similarly as illustrated in FIG. 1, which extends onto a surface of the first component.

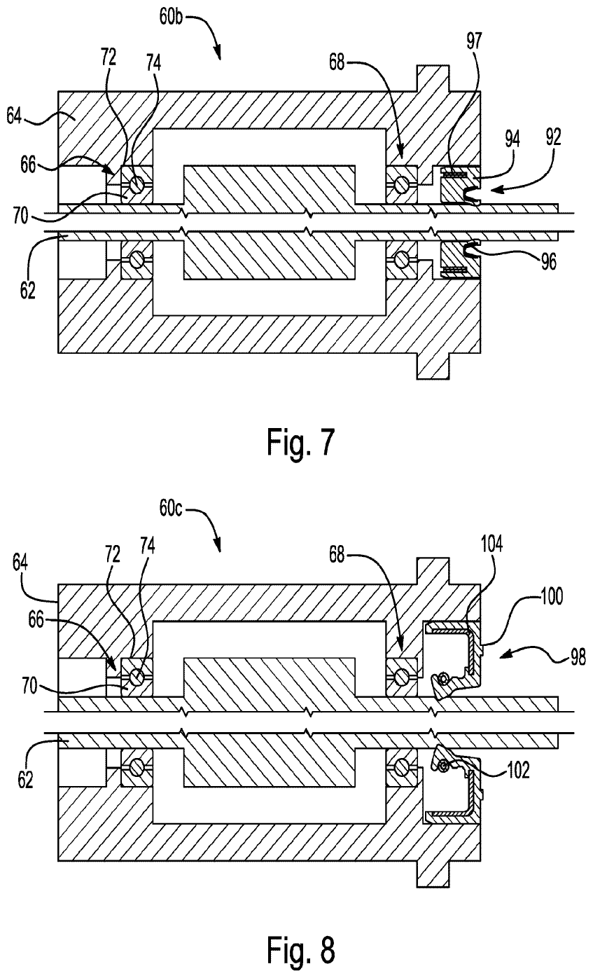

In the example configuration 60b of FIG. 7, a gap separating the first component 62 and the second component 64 is sealed by a sealing assembly 92. In this example, the sealing assembly 92 includes an electrically conductive PTFE-based sealing element 94, and an energizing element 96 that also is configured as a cantilever spring. The configuration of the sealing assembly 92 includes a pair of retention bands 96 embedded within a portion of the sealing element 94 and that aids in retaining the sealing element, similarly as illustrated in FIG. 2.

In the example configuration 60c of FIG. 8, a gap separating the first component 62 and the second component 64 is sealed by a sealing assembly 98. In this example, the sealing assembly 98 includes an electrically conductive elastomeric-based sealing element 100, and an energizing element 102 that is configured as a garter spring. The configuration of the sealing assembly 98 further includes a metal case 104 that encases a portion of the sealing element 100 and aids in retaining the sealing element.

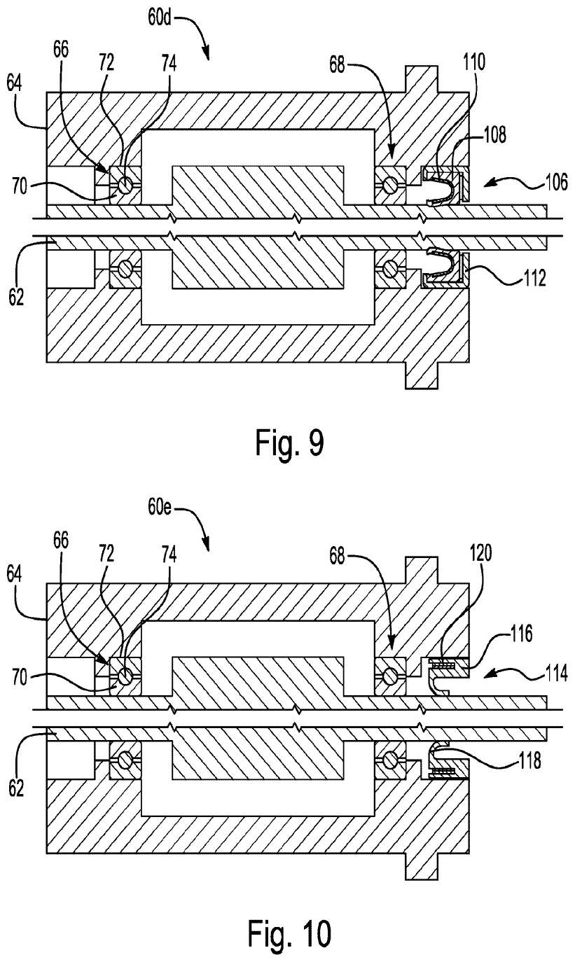

In the example configuration 60d of FIG. 9, a gap separating the first component 62 and the second component 64 is sealed by a sealing assembly 106. In this example, the sealing assembly 106 includes an electrically conductive PTFE-based sealing element 108, and an energizing element 110 that also is configured as a cantilever spring. The configuration of the sealing assembly 106 further includes a metal case 112 that encases a portion of the sealing element 108 and that aids in retaining the sealing element.

In the example configuration 60e of FIG. 10, a gap separating the first component 62 and the second component 64 is sealed by a sealing assembly 114. In this example, the sealing assembly 114 includes an electrically conductive PTFE-based sealing element 116 that includes an energizing element 118 that is configured as a spring portion of the sealing element itself, without needing a separate energizing element apart from the sealing element. The configuration of the sealing assembly 114 includes one or more metal bands 120 embedded within a portion of the sealing element 116 that aid in retaining the sealing element.

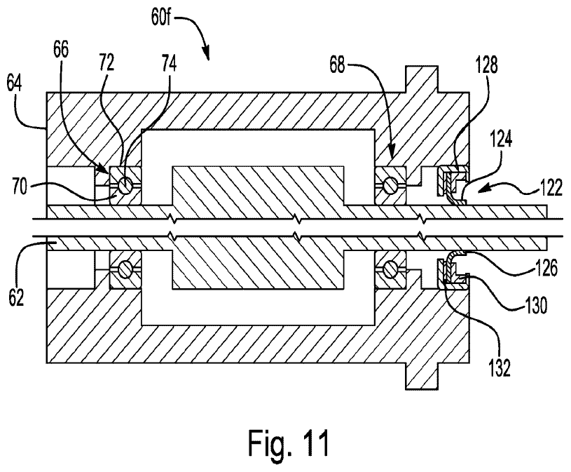

In the example configuration 60f of FIG. 11, a gap separating the first component 62 and the second component 64 is sealed by a sealing assembly 122. In this example, the sealing assembly 122 includes an electrically conductive PTFE-based sealing element 124 that includes an energizing element 126 that is configured as a spring portion of the sealing element itself, without needing a separate energizing element apart from the sealing element. The configuration of the sealing assembly 122 further includes an outer case metal case 128 positioned at least in part on a radially outward portion of the sealing element 124, and an inner elastomeric washer 130 positioned at least in part on a radially inward portion of the sealing element 124. The sealing assembly 122 further includes an additional gasket 132 located between the sealing element 124 and the metal case 128.

In each of the above examples, the sealing element of the sealing assembly is positioned and is sufficiently electrically conductive to shunt an electric current or electrical discharge between the first component 62 and the second component 64, such that any electric current or electrical discharge flows externally from or around the bearing structures 66 and 68. In this manner, damage to bearing structures, due to an electric current flow or electrical discharge through the bearing structures, is eliminated.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A sealing element for sealing a first component and a second component that operate by relative motion to each other, the sealing element comprising:
an electrically non-conductive matrix material; and
an electrically conductive additive material incorporated and dispersed into the electrically non-conductive matrix material;
wherein the electrically conductive additive material is incorporated and dispersed into the electrically non-conductive matrix material in an amount that renders the sealing element sufficiently conductive to shunt an electrical current between the first component and the second component.

2. The sealing element of claim 1, wherein the electrically conductive additive material is incorporated and dispersed into the electrically non-conductive matrix material as at least one of particulates, fibers, or powder.

3. The sealing element of claim 1, wherein a percent composition of the electrically conductive additive material relative to an entire material composition of the sealing element is 10-65%.

4. The sealing element of claim 1, wherein the electrically non-conductive matrix material includes Polytetrafluoroethylene (PTFE).

5. The sealing element of claim 1, wherein the electrically non-conductive matrix material includes an elastomeric material, a thermoplastics material, or a polyurethane material.

6. The sealing element of claim 1, wherein the electrically conductive additive material includes carbon particulates or carbon fibers.

7. The sealing element of claim 1, wherein the electrically conductive additive material includes a metallic filler formed as a powder or fibers of a metallic material.

8. The sealing element of claim 7, wherein the metallic material includes one or more of bronze, stainless steel, copper, silver, or gold.

9. A sealing assembly comprising:
a sealing element according to claim 1; and
an energizing member embedded within a portion of the sealing element that aids in energizing the sealing element.

10. The sealing assembly of claim 9, wherein the energizing member is a spring, and the spring is one of a cantilever spring, a coil spring, a canted coil spring, a helical spring, a garter spring, or an elastomeric spring.

11. (canceled)

12. A sealing assembly comprising:
a sealing element according to claim 1;
wherein the sealing element comprises an energizing member that aids in energizing the sealing element.

13. The sealing assembly of claim 9, further comprising a pair of retention bands embedded within a second portion of the sealing element that aids in retaining the sealing element.

14. A sealing assembly comprising:
a sealing element according to claim 1;
an energizing member embedded within a first portion of the sealing element that aids in energizing the sealing element;
an outer case positioned at least in part on a radially outward portion of the sealing element;
an inner washer positioned at least in part on a radially inward portion of the sealing element; and
a gasket located between the sealing element and the inner washer.

15. An assembly comprising:
a first component and a second component, wherein the first component and the second component operate by relative motion to each other;
a drive system that drives the relative motion of the first component and the second component;
at least one bearing structure that supports the relative motion of the first component and the second component; and
a sealing assembly that includes the sealing element according to claim 1, wherein the sealing element is positioned and is sufficiently conductive to shunt an electrical current between the first component and the second component such that the electrical current flows externally from or around the at least one bearing structure.

16. An assembly comprising:
a first component and a second component, wherein the first component and the second component operate by relative motion to each other;
a drive system that drives the relative motion of the first component and the second component;
at least one bearing structure that supports the relative motion of the first component and the second component; and
a sealing assembly according to claim 9, wherein the sealing element of the sealing assembly is positioned and is sufficiently conductive to shunt an electrical current between the first component and the second component such that the electrical current flows externally from or around the at least one bearing structure.

17. The assembly of claim 15, wherein the first component is a stationary component and the second component is a movable component that moves relative to the stationary component, or the first component and the second component both are movable components that move relative to each other.

18. (canceled)

19. The assembly of claim 15, further comprising an electric motor system that includes an electric motor and the drive system, and the drive system is driven by the electric motor to drive the relative motion of the first component and the second component.

20. A motor assembly comprising:
a stator;
a rotor that rotates relative to the stator;
an electric motor system that includes an electric motor and a drive system that is driven by the electric motor and that drives the rotation of the rotor relative to the stator;
at least one motor bearing that supports the rotation of the rotor relative to the stator; and
a sealing assembly that includes the sealing element according to claim 1, wherein the sealing element is positioned and is sufficiently conductive to shunt an eddy current between the rotor and the stator such that the eddy current flows externally from or around the motor bearing.

21. A motor assembly comprising:
a stator;
a rotor that rotates relative to the stator;
an electric motor system that includes an electric motor and a drive system that is driven by the electric motor and that drives the rotation of the rotor relative to the stator;
a motor bearing that supports the rotation of the rotor relative to the stator; and
a sealing assembly according to claim 9, wherein the sealing element of the sealing assembly is positioned and is sufficiently conductive to shunt an eddy current between the rotor and the stator such that the eddy current flows externally from or around the motor bearing.

22. A sealing element according to claim 1, wherein the electrically conductive additive material is incorporated and homogenously dispersed into the electrically non-conductive matrix material.
